(19) United States
(12) Patent Application Publication
(10) Pub. No.: US 2006/0141215 A1
(43) Pub. Date: Jun. 29, 2006

(54) Corrugated product

(75) Inventors: Anders Jonsson, Helsingborg (SE); Jacob Volckerts, Helsingborg (SE); Jorgen Ingvarsson, Angelholm (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignees: andres johnson, jacob volckerts, jorgan ingvarsson; mikael peterson

(21) Appl. No.: 10/533,836

(22) PCT Filed: Nov. 11, 2003
(86) PCT No.: PCT/SE03/01733

§ 371 Date: Dec. 2, 2005

(30) Foreign Application Priority Data
Nov. 12, 2002 (SE) 023353-8

(51) Int. Cl. B32B 3/28

(52) U.S. Cl. 428/156; 428/182

(57) ABSTRACT

The present invention relates to a corrugated product (10), comprising at least one first substantially plane sheet (11) and at least one second sheet (12) arranged in wave shape, wherein the first sheet is joined with the second sheet in joining areas (15), forming a framework shape having the joining areas arranged at tops (14) of the second sheet, wherein the tops are formed by thinner portions (18) of the second sheet and wherein the joining areas substantially include the entire thinner portions of the second sheet.

### FIELD OF THE INVENTION

The invention relates to a corrugated product, comprising at least one first plane sheet and at least one second sheet arranged in wave shape. The first sheet is joined with the second sheet in joining areas, forming a framework shape having the joining areas arranged at tops of the second sheet.

### PRIOR ART

The industrialization of the world has led to, and continuously leads to, increased transports and increased handling of products. This together with a focus on decreased cassation increases the demands on load carriers as well as on product protection intended to manage an increased handling and longer transport distances. The solution to this problem is often to use more rigid and more sophisticated packages and packing to protect the products. To accomplish this, the material content in the packages is increased or exchanged to a more durable packaging material. This leads to increased packing costs and environmental influence. One example of a common packing material of today is corrugated fibreboard.

It is also known that sheets of plastic material can be formed to wave shape and that such wave shaped sheets can be connected with plane sheets of similar material. One example of this is shown and described in U.S. Pat. No. 4,897,146. The corrugated material described in U.S. Pat. No. 4,897,146 is suitable to be used as roof or wall panels, but is less suitable for other purposes, such as for packing and similar.

Another material, showing good properties in connection with packing and transport, is disclosed in WO0108878. WO0108878 discloses a corrugated material comprising a plurality of material sheets, wherein at least a first plane sheet and a second wave shaped sheet of plastic material are connected to each other. For example, the corrugated material comprises three layers, wherein one corrugated layer is arranged between two plane layers. Alternatively, the corrugated material comprises two interconnected and opposite corrugated layers, which can be arranged between two plane layers. WO0108878 also discloses different material compositions in the different sheets. For example, an aluminium foil or similar material can be used in some sheet or an intermediate layer can comprise extensive amounts of filler and the outer layers can comprise less filler, wherein a plate material is provided that can resist higher loads in the direction of the channels. Further the corrugated sheet can be formed in a considerably thicker and stronger material than other layers to obtain more favourable characteristics concerning durability and impact resistance.

One drawback with this type of corrugated material of prior art is that the resistance, or strength of the material, not is satisfying. This can result in that packages and other packing as well as the products to be protected are damaged when transported or handled in another way. Also a smaller increase of the resistance leads to a substantial increase in consumption of material, which is a problem if increased demands on the material are to be met.

### THE INVENTION IN SUMMARY

One object of the present invention is to reduce the problems and drawbacks of prior art packing materials. The corrugated product according to the invention makes it possible to, inter alia, obtain reduced consumption of material while maintaining the strength and resistance of the product, or increased strength and resistance while maintaining the consumption of material. This results in reduced costs and reduced environmental influence. Except increase in strength in relation to the consumption of material improved shock absorption, improved printability and improved piling stability can be obtained by some embodiments.

According to the invention a corrugated product is provided that comprises a plurality of cooperating material sheets. A first plane sheet is joined to at least one wave shaped second sheet. The plane form of the first sheet renders it suitable as a delimiting wall in packing and packages. The wave shape of the second sheet shows marked tops and has, in cooperation with the first sheet, a favourable ability to absorb forces acting upon the tops.

In the area around the tops the second sheet is joined with the first sheet in joining areas. Together, the first sheet and the second sheet form a framework shape having favourable resistance characteristics. By forming the second sheet with thinner portions in connection with the joining areas savings of material and costs are obtained.

By that the joining areas simultaneously include substantially the whole of the thinned portions of the second sheet this savings in material and costs are obtained without having a substantial effect on the strength of the corrugated material.

According to one embodiment of the invention a third sheet can also be joined with the second sheet, so that the first sheet and the third sheet are arranged on opposite sides of the second wave shaped sheet. The third sheet can be joined with the second sheet in joining areas, which consist of non-thinned or thinned portions of the second sheet. In additional embodiments one additional wave shaped sheet is included, which suitably is arranged with its wave tops against the wave tops of the second sheet, with or without thinned portions.

The material sheets used can comprise different kinds of material. Examples of suitable base materials are fibre, plastic, plastic composite and chalk. For some applications and applications with specific demands concerning tightness, heat insulation capacity or durability against moisture, one or more of the material sheets can be arranged in a plurality of layers, wherein layers of plastic materials as polypropylene and polyethylene, for example, can be combined with layers of fibre, aluminium and other materials having suitable properties.

A corrugated product according to the invention provides, inter alia, increased strength in relation to the consumption of material in a load direction across as well as along the channels of the corrugated material. This is obtained through that the framework formed by the first plane sheet and the second corrugated sheet provide a corrugated product having extensive rigidity and strength. This in combination with the thinned portions of the second corrugated sheet simultaneously results in reduced consumption of material of the second sheet. By that the first plane sheet of the product simultaneously has been joined with substantially the whole of the thinned portions of the second sheet the strength and rigidity of the product is substantially maintained. As a result the material thereby and in accordance with the invention is provided with a reduced flexibility in and around the thinned portion when this portion of the corrugated sheet has been joined with the outer sheet.

### SHORT DESCRIPTION OF THE DRAWINGS

The invention will now be described more in detail by embodiment examples, reference being made to the accompanying drawings, in which

FIG. 1 is a schematic side view of a corrugated product according to one embodiment of the present invention,

FIG. 2 is a schematic side view of a wave shaped second sheet provided with a thinner portion in connection with the joining areas,

FIG. 3 is a schematic side view of a corrugated product comprising one substantially plane first sheet connected to a wave shaped second sheet,

FIG. 4 is a schematic side view of a corrugated product comprising a substantially plane first sheet connected to a wave shaped second sheet provided with thinner portions,

FIG. 5 is a schematic side view of a corrugated product comprising a substantially plane first sheet connected to a wave shaped second sheet provided with thinner portions according to an alternative embodiment of the present invention,

FIG. 6 is a schematic side view of a corrugated product comprising two substantially plane sheets connected to a wave shaped second sheet provided with thinner portions according to one embodiment of the present invention,

FIG. 7 is a schematic side view of a corrugated product comprising two substantially plane sheets connected to a wave shaped second sheet provided with thinner portions according to one alternative embodiment of the present invention,

FIG. 8 is a schematic side view of a corrugated product comprising three substantially plane sheets connected to two parallel wave shaped sheets provided with thinner portions,

FIG. 9 is a schematic side view of a corrugated product comprising two substantially plane sheets connected to two opposite wave shaped sheets provided with thinner portions,

FIG. 10 is a schematic cross section view illustrating one example of the composition of the sheets having a plurality of layers,

FIG. 11 is a schematic cross section view illustrating one additional example of the composition of the sheets having a plurality of layers,

FIG. 12 is a schematic cross section view illustrating one additional example of the composition of the sheets having a plurality of layers,

FIG. 13 is a schematic side view of one embodiment of a device for the manufacture of the corrugated product, and

FIG. 14 is a section view from the line I-I in FIG. 13.

### THE INVENTION

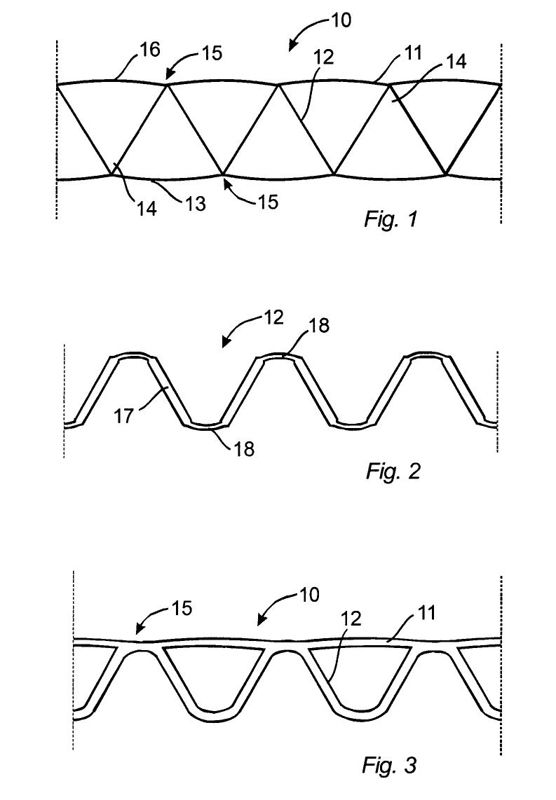

FIG. 1 is a schematic side view of a corrugated product 10 according to one embodiment of the present invention. The corrugated product 10 comprises a substantially plane first sheet 11, a wave shaped second sheet 12 and a substantially plane third sheet 13. The sheets 11-13 are arranged substantially in parallel, wherein an extension of the sheets 11-13 corresponds to the extension or longitudinal direction of the corrugated material 10. Thus, the sheets 11-13 are arranged so that they extend in the longitudinal direction of the corrugated material 10, wherein tops 14, wave crests or similar of the wave shaped second sheet 12 are arranged across the longitudinal direction of the corrugated material 10.

The first sheet 11 and the third sheet 13 are connected to the wave shaped second sheet 12 in joining areas 15, wherein the wave shaped second sheet 12 is arranged between the first sheet 11 and the third sheet 13. Thus, the first sheet 11 and the third sheet 13 are joined with the second sheet 12 in joining areas 15 forming a framework shape having the joining areas 15 arranged at the wave tops 14 of the second sheet 12.

The first substantially plane sheet 11 and the third substantially plane sheet 13 are arranged with a regular elevation 16 between adjacent joining areas 15, wherein a strong corrugated material having favourable resistance properties and shock absorbing properties is obtained. Hence, the first sheet 11 and the third sheet 13 project from the wave shaped second sheet 12 between the joining areas 15. According to this embodiment of the invention the elevations 16 are arranged with a height that is substantially lower than the height of a wave of the second sheet 12. For example, the elevation is formed as an arc of a sector of a circle or similar.

In reference to FIG. 2 the wave shaped sheet 12 is shown more in detail according to the present invention. In the embodiment of FIG. 2 the wave shaped second sheet 12 is arranged with a thinner portion 18 in connection with the joining areas 15. The wave shaped second sheet 12 thus comprises a thinner portion 18 between the bars 17 of the second sheet 12. The thinner portion 18 can be arranged with a length and thickness that in combination with length and size of the remaining portions of the second sheet 12 and the inclination of the bars 17 results in substantially the same consumption of material and/or cross section area of the second sheet 12 as of a corresponding plane sheet without thinner portions of the same width.

For example, the distance between each top 14 of the second sheet 12 is substantially the same. It can also be suitable that the second sheet 12 is corrugated so that the angle between each bar 17 is about sixty degrees. However, it is obvious for a person skilled in the art that dimensions and angles can be modified according to the application.

By forming the wave shaped second sheet 12, or the corrugated intermediary sheet, with thinner portions 18 in the sections in which the wave shaped sheet 12 is joined to the other sheets, such as external outer sheets, a saving in material is obtained in the intermediary sheet. According to one embodiment the thinner portions 18, together with the angle and shape of the bars 17 of the wave shaped second sheet 12, can form a wave shaped second sheet 12 that has the same consumption of material at the same width, i.e. cross section area, as a corresponding plane and non-corrugated intermediary sheet would have without the thinner portions 18. According to one additional embodiment the thinner portions 18 of the wave shaped second sheet 12 is joined to the outer sheets across the entire width of the thinner portion 18 and, also, with the ends or adjacent portions of the wider bars 17.

The bars 17 of the wave shaped second sheet 12 can be straight, which results in a higher strength of the wave shaped second sheet 12 than arched bars or a sinusoidal corrugation.

FIG. 3 is a schematic side view of a corrugated product 10 comprising the first sheet 11 connected to a wave shaped second sheet 12, wherein one side of the tops are arranged with a regular or invariable thickness and the other side is arranged with thinner portions being joined with the first sheet 11 over the whole of the thinned portions of the second sheet. For example, the first sheet 11 is connected with the second sheet 12 through a welded joint or similar, wherein the material of the first sheet 11 in the joining areas 15 is integrated with the material of the second sheet 12. Welding comprises melting of the sheets in the joining areas 15.

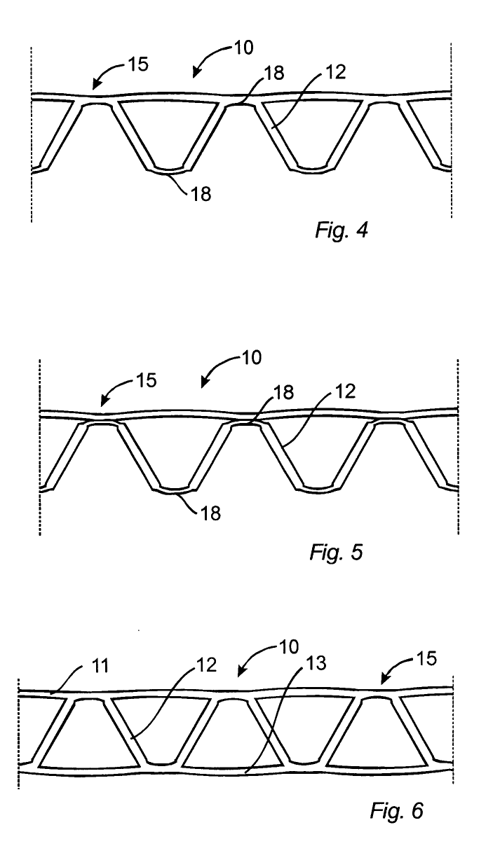

FIG. 4 is a schematic side view of a corrugated product 10 according to one additional embodiment of the invention, comprising the first sheet 11 connected to a wave shaped second sheet 12 having thinner portions 18. For example, the first sheet 11 is connected with the second sheet 12 through a welded joint or similar, wherein the material of the first sheet 11 in the joining areas 15 is integrated with the material of the second sheet 12.

FIG. 5 is a schematic side view of a corrugated product 10 comprising the first sheet 11 connected to a wave shaped second sheet 12 provided with thinner portions 18. For example, the first sheet 11 is connected with the second sheet 12 through a glued joint or similar, wherein the material of the first sheet 11 abuts the second sheet 12 in the joining areas 15.

FIG. 6 is a schematic side view of a corrugated product 10 comprising a substantially plane first sheet 11 and a substantially plane third sheet 13 connected to a wave shaped second sheet 12 provided with thinner portions 18 according to one embodiment of the present invention. In the embodiment of FIG. 6 the joining areas 15 between the first sheet 11 and the second sheet 12 comprise the entire thinner portion 18 and a thicker portion of the second sheet 12 adjacent to the thinner portion 18.

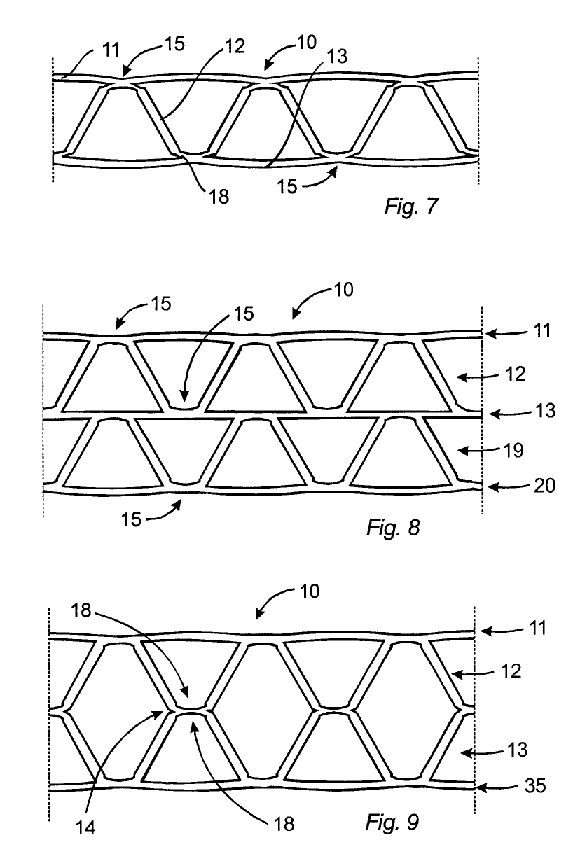

FIG. 7 is a schematic side view of a corrugated product comprising a substantially plane first sheet 11 and a substantially plane third sheet 13 connected to a wave shaped second sheet 12 provided with thinner portions 18 according to one additional embodiment of the present invention. In contrast to the embodiment of FIG. 6 the joining areas 15 between the first sheet 11 and the second sheet 12 comprise only the major part of the thinner portion 18 of the second sheet 12.

FIG. 8 is a schematic side view of a corrugated product 10 comprising a substantially plane first sheet 11 connected to a wave shaped second sheet 12 provided with thinner portions 18. The second sheet 12 is further connected to a completely plane third sheet 13, which third sheet 13 is connected to a fourth wave shaped sheet 19. The fourth wave shaped sheet 19 is further connected to a substantially plane fifth sheet 20. The wave shaped second sheet 12 is arranged between the first sheet 11 and the third sheet 13 and the wave shaped fourth sheet 19 is arranged between the third sheet 13 and the fifth sheet 20. Thus, the first sheet 11 and the third sheet 13 are arranged on opposite sides of the second wave shaped sheet 12 and the third sheet 13 and the fifth sheet 20 are arranged on opposite sides of the fourth wave shaped sheet 19. The sheets 11-13, 19 and 20 are arranged in parallel. Hence, a corrugated product 10 is provided, comprising a framework shape according to one additional embodiment of the present invention.

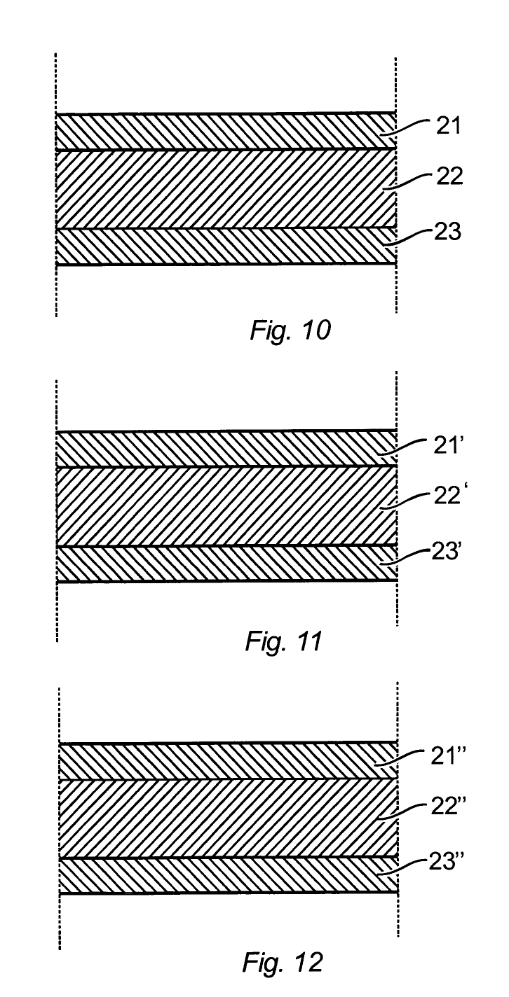

FIG. 9 is a schematic side view of a corrugated product 10 comprising two substantially plane sheets connected to two opposite wave shaped sheets provided with thinner portions. Thus, a substantially plane first sheet 11 is connected to a wave shaped second sheet 12 provided with thinner portions 18. The second sheet 12 is connected to an opposite and wave shaped third sheet 13 having thinner portions 18, wherein the wave tops 14 of the second wave shaped sheet are connected with the wave tops of the third wave shaped sheet 13. The third wave shaped sheet 13 is further connected to a fourth substantially plane sheet 35.

The corrugated material 10 and/or the different material sheets used can comprise different types of materials. Examples of suitable base materials are fibre, plastic, plastic composites, chalk, cellulose, paper or starchbased materials. Examples of plastic materials are polypropylene, polyethylene, polystyrene, PVC and similar. For applications with specific demands concerning tightness, heat insulation capacity or resistance to moisture one or more of the material sheets can be formed in a plurality of layers, wherein layers of plastic materials, such as polypropylene and polyethylene, can be combined with layers of fibre, aluminium and other materials or mixtures thereof having suitable properties.

At least the second sheet is, for example, formed in a thermoplastic material or a material comprising a thermoplastic or a compound thereof. The material in the sheets can then, for example, comprise a filler of chalk or a filler of fibre in addition to the thermoplastic. It is however obvious for a layman that mixture of materials and structure can be modified as desired.

FIG. 10-FIG. 12 are schematic cross section views of examples of the composition of the sheets. In the embodiment of FIG. 10 the sheets comprise a first layer 21, a second layer 22 and a third layer 23, wherein the first layer 21 and the third layer 23 are arranged on opposite sides of the second layer 22. The first layer 21 comprises, for example, polypropylene or polyethylene, the second layer 22 comprises, for example, polypropylene or polyethylene mixed with chalk and the third layer comprises, for example, polypropylene or polyethylene.

In reference to FIG. 11 the first layer 21′ comprises polypropylene mixed with talc, the second layer 22′ a mixture of plastic and chalk and the third layer 23′ polypropylene mixed with talc.

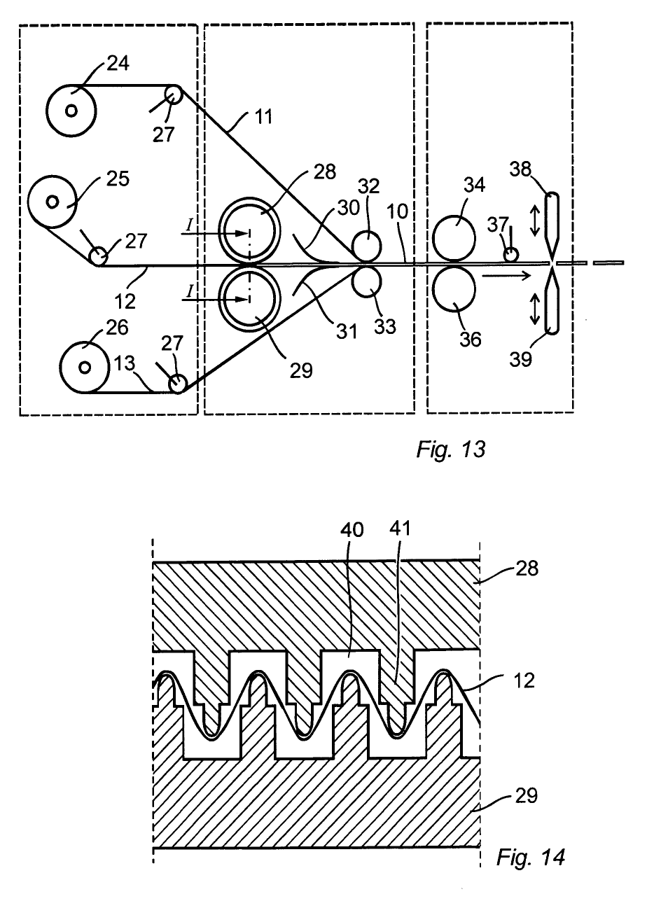

In reference to FIG. 12 the first layer 21″ comprises aluminium foil, the second layer 22″ a mixture of polypropylene and chalk and the third layer 23″ polypropylene. It is however clear that the number of layers and the composition of materials can be varied further and is not limited to the given examples.

Thermoplastic is a generic term for polyolefines, such as polypropylene and polyethylene. Chalk is a mineral sediment consisting of, for example, calcium carbonate, dolomite and/or talc. Chalk is a generic term for calcium carbonate, dolomite and/or talc. By choosing the composition of the material sheets in a suitable manner, different properties of the corrugated material are obtained. According to one embodiment the corrugated material can consist of only one optional material, such as for example plastic, fibre, aluminium or any other suitable material. In further one embodiment the material sheets can have different compositions to obtain specific properties. In yet another embodiment each of the material sheets can have different layers, each consisting of different materials, such as fibre, plastic, plastic/fibre, plastic/chalk.

The sheets of the corrugated material can be glued together in a conventional manner. Sheets of materials such as plastic or plastic compound can advantageously be melted or welded together without adding any adhesive in the form of glue or similar. By providing those of the outer layers 21 and/or 23 of the sheets 11, 12, 13 that are in contact with another of the sheets 11, 12, 13 with a material having lower melting point a welding can be obtained without melting other layers 21, 22, 23 of the material sheets 11, 12, 13.

FIG. 13 is a schematic view of a device for manufacturing the corrugated product 10. A first part A, illustrated by dash and dot lines, comprises a first roll 24, a second roll 25 and a third roll 26, all being reeled up with a suitable sheet material, and conventional web tension means 27. The different sheet materials are brought together in a second part B and form different layers of the final corrugated material. It should be noted that material thickness, relative distance between different components and other geometric relationships in FIG. 13 as well as in the subsequent drawings, are not in scale. Several dimensions and distances have been changed in relation to real circumstances to illustrate features of the invention more clearly.

The elements of part A can all be arranged according to prior art. It is however important to note that different sheet materials, both thickness and material as such, can be arranged on the different rolls, as described above.

Before a second sheet 12, that is to be corrugated or formed in a wave shape, is brought together with the other sheets, it is suitably corrugated by means of a corrugation device. According to the illustrated embodiment the corrugation device comprises an upper corrugation roll 28 and a lower corrugation roll 29, which are described in more detail in reference to FIG. 14. In such an embodiment it can be suitable to preheat the sheet 12 before the corrugation and/or to heat the corrugation rolls 28 and 29.

After the corrugation device the corrugated sheet 12 is brought in between at least one set of upper core bars 30 and one set of lower core bars 31. An upper sheet 11 from the first roll 24 and a lower sheet 13 from the third roll 26 are brought together with the corrugated sheet 12 at the core bars 30 and 31. The core bars 30 and 31 extend in the mutual long direction V of the sheets, which is indicated by the corresponding arrow in FIG. 13. Both sets of core bars 30 and 31 are suspended behind or outside the sheets in a manner which is not illustrated in more detail.

The sheets are heated by the core bars 30 and 31 and are joined to a corrugated plate material by cooperation with an upper pressure roll 32 and a lower pressure roll 33, which also force the sheets forward. After joining the ready-formed plate material can be brought forward in the direction of arrow V in a conventional manner by a propelling upper driving roll 34 and a propelling lower driving roll 36. The driving rolls 34 and 36 are included in a third part C, which, in a conventional manner, can comprise at least one laterally adjustable cutting mechanism 37 for cutting the plate material to desired width and one cutting mechanism for cutting the plate material to desired length. In the embodiment shown the cutting mechanism for length cutting comprises an upper cutter 38 and a lower cutter 39 cooperating with the upper cutter 38. Suitably, the cutters move up and down and cut the plate material into plates of suitable length. The size of the plates is highly dependent on the application they are intended for. The third part C as such is not part of the invention and can be arranged according to the current application.

In reference to FIG. 14 the upper corrugation roll 28 and the lower corrugation roll 29 are arranged with recesses 40 and rounded tops 41. The tops 41 project from the periphery of the corrugation rolls 28, 29 and extend, in parallel, around the entire circumference of the corrugation rolls 28, 29. The tops 41 on the upper corrugation roll 28 overlap the tops 41 of the lower corrugation roll 29. Hence, the tops 41 and the recesses 40 of the upper corrugation roll 28 are horizontally displaced in relation to the tops 41 and the recesses 40 of the lower corrugation roll 29. Further, the tops 41 of the upper corrugation roll 28 project into the recesses 40 of the lower corrugation roll 29. The shape of the tops and recesses, respectively, is adapted to the shape of the core bars, so that the sheet is corrugated to fit between the upper and lower row of core bars 17, 18 before it reaches the core bars.

Preferably the tops 41 are rounded to suitably stretch the sheet at and around the portion of the sheet contacting the tops 41. The tops 41 are narrower than the recesses 40 to obtain a more favourable corrugation of the sheet to be corrugated and to improve the properties of the corrugated sheet. Consequently, the corrugated sheet is provided with linear portions having a thicker profile and more stretched, and thus thinner, folds. The sheet also runs freely in the space between the tops 41 and the recesses 40.

It should be noted that material thicknesses, relative distances between different components and other geometric relationships in the drawings are not in scale.

1. Corrugated product (10), comprising at least one first plane sheet (11) and at least one second sheet (12) arranged in wave shape, wherein the first sheet is joined with the second sheet in joining areas (15), forming a framework shape having the joining areas arranged at tops (14) of the second sheet, characterized in
that at least the second sheet (12) is arranged with a thinner portion (18) in connection with the joining areas (15), and
that the joining areas between the first sheet and the second sheet substantially include the entire thinner portion (18) of the second sheet (12).

2. Corrugated product according to claim 1, wherein the joining areas between the first sheet and the second sheet include the entire thinner portion (18) of the second sheet.

3. Corrugated product according to claim 2, wherein the joining areas between the first sheet and the second sheet include the entire thinner portion (18) and a thicker portion of the second sheet (12) adjacent the thinner portion.

4. Corrugated product according to claim 3, wherein the thinner portion (18) is arranged with a length and thickness that in combination with the length, thickness and shape of remaining portions of the second sheet results in a substantially similar consumption of material and/or cross section area of the second sheet as of a corresponding plane sheet without thinner portions of the same width.

5. Corrugated product according to claim 1, wherein at least the second sheet is formed in a thermoplastic material.

6. Corrugated product according to claim 5, wherein the second sheet is formed in a material comprising a polyolefine or a compound thereof.

7. Corrugated product according to claim 6, wherein the material comprises a filler of chalk.

8. Corrugated product according to claim 6, wherein at least the first sheet and the second sheet are joined by welding.

9. Corrugated product according to claim 1, wherein the second sheet arranged in wave shape comprises straight portions extending between the tops.

10. Corrugated product according to claim 1, wherein a third plane sheet is connected to the wave shaped second sheet in joining areas, so that the wave shaped second sheet is arranged between both of the substantially plane sheets.

11. Corrugated product according to claim 1, wherein a plane third sheet is arranged opposite the first plane sheet with an intermediate and wave shaped fourth sheet arranged with tops joined with tops of the second wave shaped sheet.

12. Corrugated product according to claim 1, wherein at least the first plane sheet (11) is arranged with a regular elevation (16) between adjacent joining areas (15).
